(19) United States
(12) Patent Application Publication
(10) Pub. No.: US 2023/0037541 A1
(43) Pub. Date: Feb. 9, 2023

(54) METHOD AND SYSTEM FOR SYNTHESIZING SPEECHES BY SCORING SPEECHES

(71) Applicant: Xinapse Co., Ltd., Seoul (KR)

(72) Inventors: Dong Won JOO, Seoul (KR); Jinbeom KANG, Seoul (KR); Yongwook NAM, Seoul (KR); Jung Hoon Lee, Yongin-si (KR)

(21) Appl. No.: 17/813,506

(22) Filed: Jul. 19, 2022

(30) Foreign Application Priority Data
Jul. 29, 2021 (KR) 10-2021-0100176
Jul. 30, 2021 (KR) 10-2021-0100898
May 30, 2022 (KR) 10-2022-0066187

(51) Int. Cl. G10L 13/04

(52) U.S. Cl. CPC G10L 13/04

(57) ABSTRACT

A method of synthesizing speeches by scoring the speeches is proposed. The method may include generating a spectrogram based on utterer information and a text and generating a plurality of sub-speeches corresponding to the spectrogram. The method may also include selecting one of the plurality of sub-speeches and generating a final speech by using the selected sub-speech.

### CROSS-REFERENCE TO RELATED APPLICATION

This application is based on and claims priority under 35 U.S.C. § 119 to Korean Patent Application Nos. 10-2021-0100176, filed on Jul. 29, 2021, 10-2021-0100898, filed on Jul. 30, 2021, and 10-2022-0066187, filed on May 30, 2022, in the Korean Intellectual Property Office, the disclosure of each of which is incorporated by reference herein in its entirety.

### BACKGROUND

### Technical Field

The disclosure relates to a method and system for synchronizing speeches by scoring the speeches.

### Description of the Related Technology

Recently, with the development of artificial intelligence technology, an interface using a speech signal is becoming common. In this regard, studies on speech synthesis technology enabling a synthesized speech to be uttered according to a given situation are being actively conducted.

The speech synthesis technology is applied to various fields, such as virtual assistants, audiobooks, automatic interpretations and translations, and virtual voice actors, in combination with speech recognition technology based on artificial intelligence.

### SUMMARY

Provided is artificial intelligence-based speech synthesis technology capable of realizing a high-quality speech as if an utterer actually speaks.

Provided is artificial intelligence-based speech synthesis technology capable of realizing a speech from which abnormal noise is removed.

Additional aspects will be set forth in part in the description which follows and, in part, will be apparent from the description, or may be learned by practice of the presented embodiments of the disclosure.

According to an aspect of an embodiment, a method includes: generating a spectrogram based on utterer information and a text; generating a plurality of sub-speeches corresponding to the spectrogram; selecting one of the plurality of sub-speeches; and generating a final speech by using the selected sub-speech.

The selecting may include selecting a sub-speech based on scores respectively corresponding to the plurality of sub-speeches.

The scores may be calculated by: deriving an s-th score based on an s-th sample value and an (s−1)th sample value of the selected sub-speech; deriving an (s+1)th score based on an (s+1)th sample value and the s-th sample value of the selected sub-speech; and adding the s-th score and the (s+1)th score, wherein s may include a natural number equal to or greater than 2.

The s-th score may be a square of a difference between the s-th sample value and the (s−1)th sample value.

A last value of s may denote a number of samples of the selected sub-speech.

The selecting may include selecting a sub-speech of which a corresponding score is lowest from among the plurality of sub-speeches.

The method may further include, after the generating of the spectrogram, receiving an input of setting n corresponding to a number of the plurality of sub-speeches, wherein n includes a natural number equal to or greater than 2, and the generating of the plurality of sub-speeches includes generating n sub-speeches.

The generating of the final speech may include removing residual abnormal noise from the selected sub-speech.

According to an aspect of another embodiment, a computer-readable recording medium has recorded thereon a program for executing the method on a computer.

According to an aspect of another embodiment, a system includes: at least one memory; and at least one processor operating by at least one program stored in the at least one memory, wherein the at least one processor performs the method.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a diagram schematically showing an operation of a speech synthesis system.

FIG. 2 is a diagram of an embodiment of a speech synthesis system.

FIG. 3 is a diagram showing an embodiment of outputting a mel-spectrogram through a synthesizer.

FIG. 4 is a diagram of an embodiment of a speech synthesis system.

FIG. 5 is a diagram showing an embodiment of a probability distribution generated by a vocoder.

FIG. 6 is a diagram showing an embodiment of a speech including abnormal noise.

FIG. 7 is a diagram showing an embodiment of generating a final speech through scoring.

FIG. 8 is a diagram showing an embodiment of a score calculation for a sub-speech.

FIG. 9 is a diagram showing an embodiment of determining whether a speech includes abnormal noise;

FIGS. 10A and 10B are diagrams showing an embodiment of correcting at least one sample value from among sample values of a speech.

FIG. 11 is a flowchart of an embodiment of a method of generating a speech by scoring speeches.

### DETAILED DESCRIPTION

Examples of a general speech synthesis method include various methods, such as concatenative synthesis (unit selection synthesis (USS)) and statistical parametric speech synthesis (hidden Markov model (HMM)-based speech synthesis (HTS)). The USS is a method of cutting speech data in units of phonemes, storing the same, and finding and concatenating sound pieces suitable for utterance during speech synthesis, and the HTS is a method of generating a statistical model by extracting parameters corresponding to speech features and reconfiguring a text to a speech based on the statistical model. However, the general speech synthesis method has a lot of limitations in synthesizing a natural speech reflecting an utterance style or emotional expression of an utterer.

Accordingly, recently, a speech synthesis method of synthesizing speeches from a text, based on an artificial neural network, is receiving attention.

In general, to generate a synthesized speech without abnormal noise, technology of calculating scores of attention alignments corresponding to a plurality of spectrograms and generating a speech from a best-quality spectrogram selected based on the scores is applied or technology of removing abnormal noise through correction on a speech including abnormal noise is applied.

However, such technology incus a loss of a sample, and thus the disclosure proposes speech synthesis technology capable of preventing or reducing a loss of a sample while realizing a speech that does not include abnormal noise.

All terms including descriptive or technical terms which are used in embodiments should be construed as having meanings that are obvious to one of ordinary skill in the art. However, the terms may have different meanings according to the intention of one of ordinary skill in the art, precedent cases, or the appearance of new technologies. Also, some terms may be arbitrarily selected by the applicant, and in this case, the meaning of the selected terms will be described in detail in the corresponding description. Thus, the terms used in the embodiments have to be defined based on the meaning of the terms together with the description throughout the specification.

The embodiments may have various modifications and various forms, and some embodiments are illustrated in the drawings and are described in detail in the detailed description. However, this is not intended to limit the embodiments to particular modes of practice, and it will be understood that all changes, equivalents, and substitutes that do not depart from the spirit and technical scope of the embodiments are encompassed in the embodiments. Also, the terms used in the present specification are only used to describe embodiments, and are not intended to limit the embodiments.

Unless the terms used in the embodiments are defined otherwise, the terms may have the same meanings as generally understood by one of ordinary skill in the art to which the embodiments belong. Terms that are defined in commonly used dictionaries should be interpreted as having meanings consistent with those in the context of the related art, and should not be interpreted in ideal or excessively formal meanings unless clearly defined in the embodiments.

The detailed description of the disclosure to be described below refers to the accompanying drawings, which illustrate specific embodiments in which the disclosure may be practiced. These embodiments are described in sufficient detail to enable one of ordinary skill in the art to practice the disclosure. It is to be understood that various embodiments of the disclosure are different from each other, but need not be mutually exclusive. For example, specific shapes, structures, and characteristics described herein may be changed from one embodiment to another embodiment and implemented without departing from the spirit and scope of the disclosure. In addition, it should be understood that positions or arrangements of individual elements in each embodiment may be changed without departing from the spirit and scope of the disclosure. Accordingly, the detailed description described below is not implemented in a limiting sense, and the scope of the disclosure may encompass the scope claimed by claims and all scopes equivalent thereto. In drawings, the like reference numerals denote the same or similar elements over various aspects.

Meanwhile, in the present specification, technical features described individually in one drawing may be implemented individually or simultaneously.

n the present specification, the term “unit” may be a hardware component such as a processor or circuit and/or a software component that is executed by a hardware component such as a processor. Hereinafter, various embodiments of the disclosure will be described in detail with reference to accompanying drawings to enable one of ordinary skill in the art to easily execute the disclosure.

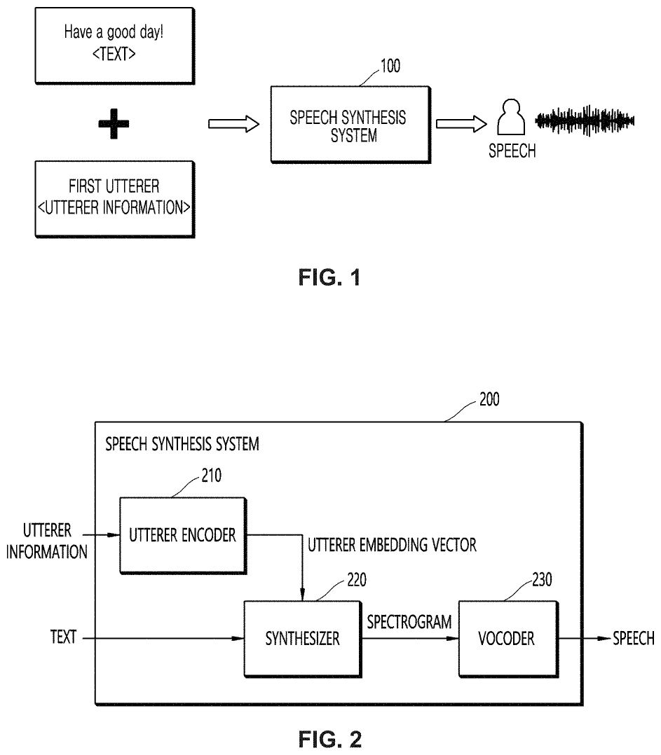

FIG. 1 is a diagram schematically showing an operation of a speech synthesis system 100.

A speech synthesis apparatus is an apparatus for artificially converting a text into a human speech.

For example, the speech synthesis system 100 of FIG. 1 may be a speech synthesis system based on an artificial neural network. The artificial neural network denotes models in general, in which artificial neurons forming a network through coupling of synapses have a problem-solving ability by changing coupling strength of the synapses through learning.

The speech synthesis system 100 may be implemented as any one of various types of devices, such as a personal computer (PC), a server device, a mobile device, and an embedded device. Specific examples may include a smartphone, a tablet device, an augmented reality (AR) device, an Internet of things (IoT) device, an autonomous vehicle, a robotics, a medical device, an electronic book terminal, and a navigation device, which perform speech synthesis by using the artificial neural network, but are not limited thereto.

In addition, the speech synthesis system 100 may correspond to a dedicated hardware (HW) accelerator mounted on the above device. Alternatively, the speech synthesis system 100 may be a hardware accelerator, such as a neural processing unit (NPU), a tensor processing unit (TPU), or a neural engine, which is a dedicated module for driving the artificial neural network, but is not limited thereto.

Referring to FIG. 1, the speech synthesis system 100 may receive an input of a text and specific utterer information. For example, as shown in FIG. 1, the speech synthesis system 100 may receive, as the input of the text, “Have a good day!” and receive, as an input of the utterer information, “first utterer”.

The “first utterer” may correspond to a speech signal or speech sample indicating utterance features of the pre-set first utterer. For example, the utterer information may be received from an external device through a communication unit included in the speech synthesis system 100. Alternatively, the utterer information may be input from a user through a user interface of the speech synthesis system 100 or selected from among various pieces of utterer information pre-stored in a database of the speech synthesis system 100, but is not limited thereto.

The speech synthesis system 100 may output a speech based on the received input of the text and specific utterer information. For example, the speech synthesis system 100 may receive, as inputs, “Have a good day!” and “first utterer”, and output a speech for “Have a good day!” on which the utterance features of the first utterer are reflected. The utterance features of the first utterer may include at least one of various elements, such as voice, a cadence, pitch, and an emotion of the first utterer. In other words, the output speech may be the voice of the first utterer naturally speaking “Have a good day!”. Specific operations of the speech synthesis system 100 will be described below with reference to FIGS. 2 through 4.

FIG. 2 is a diagram of an embodiment of a speech synthesis system 200. The speech synthesis system 200 of FIG. 2 may be the same as the speech synthesis system 100 of FIG. 1.

Referring to FIG. 2, the speech synthesis system 200 may include an utterer encoder 210, a synthesizer 220, and a vocoder 230. Only components related to an embodiment are illustrated for the speech synthesis system 200 of FIG. 2. Thus, it would be obvious to one of ordinary skill in the art that the speech synthesis system 200 may further include other general-purpose components in addition to the components shown in FIG. 2.

The speech synthesis system 200 of FIG. 2 may output a speech by receiving inputs of utterer information and text.

For example, the utterer encoder 210 of the speech synthesis system 200 may receive the input of utterer information and generate an utterer embedding vector. The utterer information may correspond to a speech signal or speech sample of an utterer. The utterer encoder 210 may receive the speech signal or speech sample of the utterer to extract utterance features of the utterer therefrom, and indicate the utterance features as the utterer embedding vector.

The utterance features of the utterer may include at least one of various elements, such as an utterance speed, a pause interval, pitch, tone, a cadence, intonation, and an emotion. In other words, the utterer encoder 210 may indicate discontinuous data values included in the utterer information in a vector including continuous numbers. For example, the utterer encoder 210 may generate the utterer embedding vector based on at least one or a combination of various artificial neural network models, such as a pre-net, a CBHG module, a deep neural network (DNN), a convolutional neural network (CNN), a recurrent neural network (RNN), a long short-term memory network (LSTM), and a bidirectional recurrent deep neural network (BRDNN).

For example, the synthesizer 220 of the speech synthesis system 200 may output a spectrogram by receiving, as inputs, the text and the utterer embedding vector indicating the utterance features of the utterer.

The synthesizer 220 of the speech synthesis system 200 may include an encoder (not shown) and a decoder (not shown). It would be obvious to one of ordinary skill in the art that the synthesizer 220 may further include other general-purpose components.

The utterer embedding vector indicating the utterance features of the utterer may be generated by the utterer encoder 210 as described above, and the encoder or decoder of the synthesizer 220 may receive, from the utterer encoder 210, the utterer embedding vector indicating the utterance features of the utterer.

The encoder of the synthesizer 220 may generate a text embedding vector by receiving the text as an input. The text may include a sequence of characters of a specific natural language. For example, the sequence of characters may include alphabet letters, numbers, punctuation marks, or other special characters.

The encoder of the synthesizer 220 may separate the input text into units of alphabets, units of letters, or units of phonemes, and input the separated text into an artificial neural network model. For example, the encoder of the synthesizer 220 may generate the text embedding vector based on at least one or a combination of various artificial neural network models, such as a pre-net, a CBHG module, DNN, CNN, RNN, LSTM, and BRDNN.

Alternatively, the encoder of the synthesizer 220 may separate the input text a plurality of short texts, and generate a plurality of text embedding vectors respectively for the short texts.

The decoder of the synthesizer 220 may receive, as inputs, the utterer embedding vector and the text embedding vector from the utterer encoder 210. Alternatively, the decoder of the synthesizer 220 may receive, from the utterer encoder 210, the input of utterer embedding vector, and receive, from the encoder of the synthesizer 220, the input of text embedding vector.

The decoder of the synthesizer 220 may generate the spectrogram corresponding to the input text by inputting the utterer embedding vector and the text embedding vector into the artificial neural network model. In other words, the decoder of the synthesizer 220 may generate the spectrogram for the input text, to which the utterance features of the utterer are reflected. For example, the spectrogram may correspond to a mel-spectrogram, but is not limited thereto. In other words, the spectrogram or mel-spectrogram corresponds to verbal utterance of a sequence of characters of a specific natural language.

The spectrogram is obtained by visualizing a spectrum of a speech signal as a graph. In the spectrogram, an x-axis denotes time and a y-axis denotes a frequency, and a value of a frequency per time may be represented in a color according to a size of the value. The spectrogram may be a result obtained by performing short-time Fourier transform (STFT) on the continuously provided speech signal.

The STFT is a method of dividing a speech signal into intervals of certain lengths, and applying Fourier transform on each interval. Here, the result obtained by performing the STFT on the speech signal is in a complex value, and thus the spectrogram that loses phase information and includes only magnitude information by taking an absolute value of the complex value may be generated.

Meanwhile, the mel-spectrogram is obtained by readjusting frequency intervals of the spectrogram in a mel scale. An auditory organ of a person is more sensitive in a low frequency band than in a high frequency band, and the mel scale represents a relationship between a physical frequency and a frequency actually recognized by a real person by reflecting such a characteristic. The mel-spectrogram may be generated by applying a mel scale-based filter bank to the spectrogram.

Although not shown in FIG. 2, the synthesizer 220 may further include an attention module (not shown) for generating attention alignment. The attention module is a module that learns which one of outputs of all time-steps of the encoder of the synthesizer 220 is most associated with an output of a specific time-step of the decoder of the synthesizer 220. A high-quality spectrogram or mel-spectrogram may be output by using the attention module.

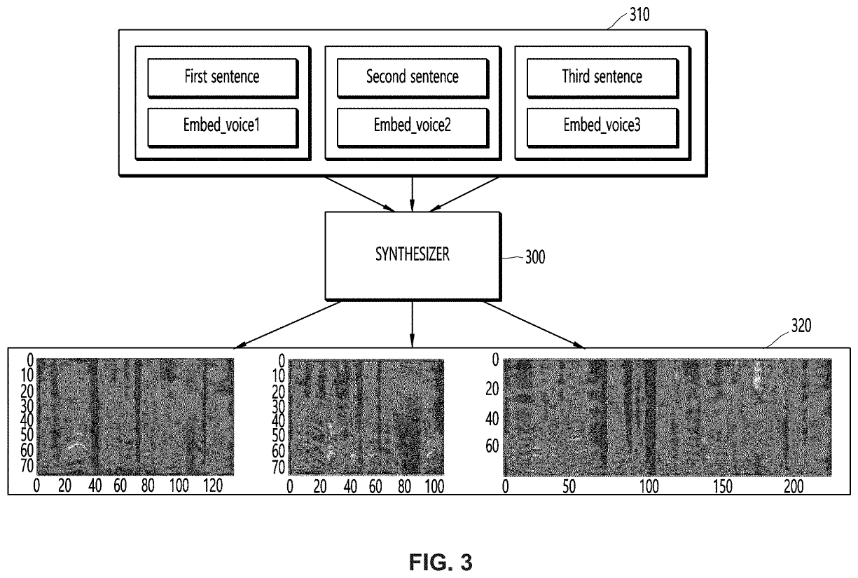

FIG. 3 is a diagram showing an embodiment of outputting a mel-spectrogram 320 through a synthesizer 300. The synthesizer 300 of FIG. 3 may be the same as the synthesizer 220 of FIG. 2.

Referring to FIG. 3, the synthesizer 300 may receive a list 310 of input texts and utterer embedding vectors corresponding to the input texts. For example, the synthesizer 300 may receive an input of the list 310 including an input text of a “‘first sentence” and a corresponding utterer embedding vector of “embed_voice1”, an input text of a “second sentence” and a corresponding utterer embedding vector of “embed_voice2”, and an input text of a “third sentence” and a corresponding utterer embedding vector “embed_voice3”.

The synthesizer 300 may generate as many mel-spectrograms 320 as the number of input texts included in the received list 310. Referring to FIG. 3, the mel-spectrograms 320 respectively corresponding to the input texts of “first sentence”, “second sentence”, and “third sentence” are generated.

Alternatively, the synthesizer 300 may generate as many mel-spectrograms 320 and attention alignments as the number of input texts. Although not shown in FIG. 3, for example, the attention alignments respectively corresponding to the input texts of “first sentence”, “second sentence”, and “third sentence” may be additionally generated. Alternatively, the synthesizer 300 may generate a plurality of mel-spectrograms and a plurality of attention alignments for each of the input texts.

Referring back to FIG. 2, the vocoder 230 of the speech synthesis system 200 may generate the spectrogram output from the synthesizer 220 as an actual speech. As described above, the output spectrogram may be a mel-spectrogram.

According to an embodiment, the vocoder 230 may generate the spectrogram output from the synthesizer 220 as an actual speech signal by using inverse short-time Fourier transform (ISFT). Because the spectrogram or mel-spectrogram does not include phase information, when the speech signal is generated by using ISFT, the phase information of the spectrogram or mel-spectrogram is not considered.

According to another embodiment, the vocoder 230 may generate the spectrogram output from the synthesizer 220 as an actual speech signal by using a Griffin-Lim algorithm. The Griffin-Lim algorithm is an algorithm of estimating phase information from magnitude information of the spectrogram or mel-spectrogram.

Alternatively, the vocoder 230 may generate the spectrogram output from the synthesizer 220 as an actual speech signal, based on, for example, a neural vocoder.

The neural vocoder is an artificial neural network that receives, as an input, a spectrogram or mel-spectrogram, and generating a speech signal. The neural vocoder may learn relationships between spectrograms or mel-spectrograms and speech signals through a large amount of data, and generate a high-quality actual speech signal through the relationships.

The neural vocoder may correspond to a vocoder based on an artificial neural network model, such as WaveNet, Parallel WaveNet, WaveRNN, WaveGlow, or MelGAN, but is not limited thereto.

For example, a WaveNet vocoder includes a plurality of dilated causal convolution layers, and is an autoregressive model using sequential features between speech samples. A WaveRNN vocoder is an autoregressive model in which the plurality of dilated causal convolution layers of the WaveNet vocoder are replaced by a gated recurrent unit (GRU). A WaveGlow vocoder may be trained such that a simple distribution, such as a Gaussian distribution, is obtained from a spectrogram dataset (x) by using an invertible transform function. The WaveGlow vocoder may output a speech signal from a sample of the Gaussian distribution by using an inverse function of the transform function after the training is completed.

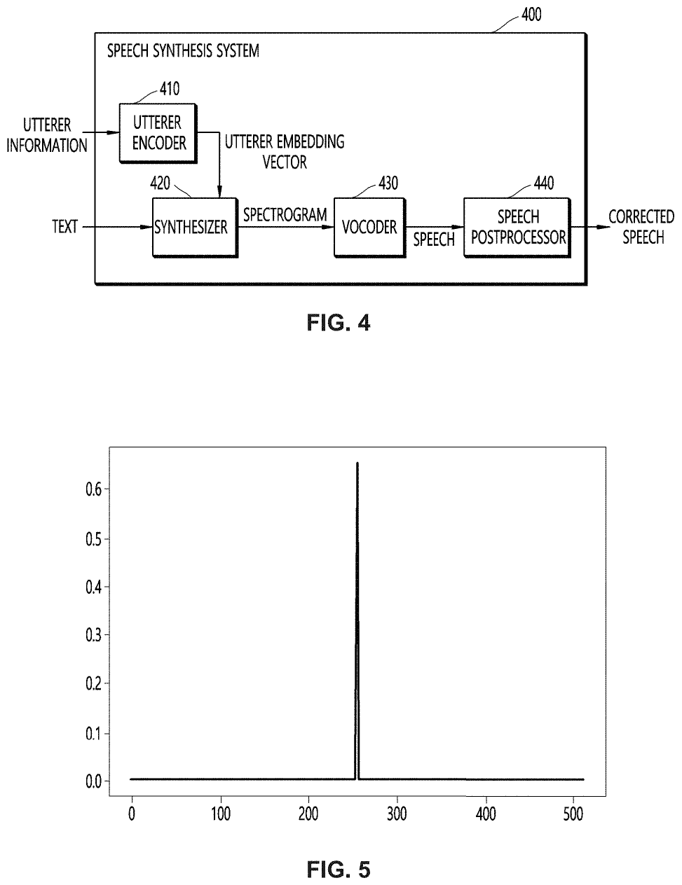

FIG. 4 is a diagram of an embodiment of a speech synthesis system 400. The speech synthesis system 400 of FIG. 4 may be the same as the speech synthesis system 100 of FIG. 1 or the speech synthesis system 200 of FIG. 2.

Referring to FIG. 4, the speech synthesis system 400 may include an utterer encoder 410, a synthesizer 420, a vocoder 430, and a speech postprocessor 440. Only components related to an embodiment are illustrated for the speech synthesis system 400 of FIG. 4. Thus, it would be obvious to one of ordinary skill in the art that the speech synthesis system 400 may further include other general-purpose components in addition to the components shown in FIG. 4.

The utterer encoder 410, synthesizer 420, and vocoder 430 of FIG. 4 may be respectively the same as the utterer encoder 210, synthesizer 220, and vocoder 230 of FIG. 2 described above. Accordingly, descriptions about the utterer encoder 410, synthesizer 420, and vocoder 430 of FIG. 4 are not provided again.

As described above, the synthesizer 420 may generate a spectrogram or mel-spectrogram corresponding to a text, based on the text and utterer information. Also, the vocoder 430 may generate an actual speech by using the spectrogram or mel-spectrogram as an input.

The speech postprocessor 440 of FIG. 4 may receive an input of the speech generated by the vocoder 430 and perform a postprocessing operation, such as speech selection or noise removal, through scoring. The speech postprocessor 440 may generate a corrected speech to be finally heard by a user by performing the postprocessing operation on the input speech.

Meanwhile, the speech generated by the vocoder 430 based on the spectrogram may include abnormal noise. When the abnormal noise is included in the speech generated by the vocoder 430, a ticking sound may occur.

For example, the vocoder 430 may correspond to a WaveRNN vocoder, and the WaveRNN vocoder may correspond to an autoregressive generative model including a GRU cell and a fully-connected (FC) layer. An output layer of the vocoder 430 may include N neurons, and N logits may be generated respectively from the N neurons.

The vocoder 430 may generate a probability distribution from the generated logits, and determine sample values of the speech based on the probability distribution. As such, because the sample values of the speech are determined based on the probability distribution of the logits, and the abnormal noise may be generated at a low probability.

FIG. 5 is a diagram showing an embodiment of the probability distribution generated by the vocoder 430.

According to an embodiment, the vocoder 430 may generate the probability distribution of the logits by inputting the spectrogram into an artificial neural network model, and derive the sample values of the speech based on the generated probability distribution.

FIG. 5 illustrates an example of the probability distribution generated as the vocoder 430 inputs, into a softmax function, the logits generated by inputting the spectrogram into the artificial neural network model. In FIG. 5, an x-axis of the probability distribution may correspond to a logit value and a y-axis thereof may correspond to a probability value. The softmax function is a function having a characteristic of normalizing all input values to a value between 0 and 1 for an output, and a total sum of output values is always 1.

For example, the artificial neural network model may correspond to an autoregressive generative model including a GRU cell and an FC layer. Also, an output layer of the artificial neural network model may include 512 neurons, and 512 logits may be generated from the 512 neurons, but the number of logits generated from the output layer is not limited thereto.

The vocoder 430 may derive the sample values of the speech based on the generated probability distribution, and the sample values of the speech may be derived according to Equation 1 below.

$$sample = \frac{2 \times dist\_sample}{n\_class - 1} - 1 \qquad [ Equation 1 ]$$

In Equation 1, sample denotes a sample value of a speech generated based on a probability distribution, n_class denotes the number of logit values in the probability distribution, and dist_sample denotes a logit value output based on the probability distribution. According to Equation 1, the sample value of the speech generated by the vocoder 430 may have a value between −1 and 1.

Referring to FIG. 5, it is identified that it is highly likely for a value of dist_sample to be 256, based on the probability distribution. For example, when the value of dist_sample is output to be 256, based on the probability distribution, a value of n_class is 512, and thus the sample value of the generated speech is close to 0.

However, the value of dist_sample may be output to be a value other than 256 at a low probability, based on the probability distribution, and in this case, the speech generated by the vocoder 430 may include abnormal noise.

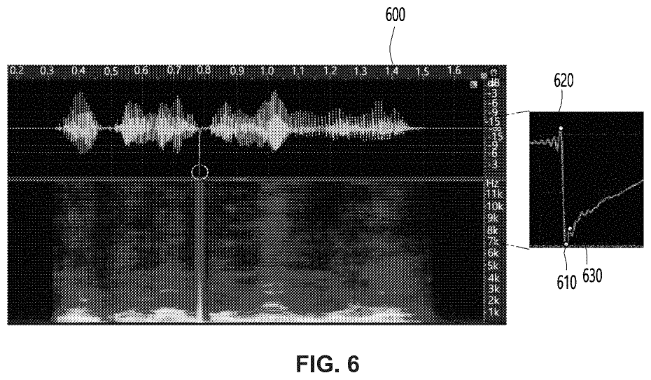

FIG. 6 is a diagram showing an embodiment of a speech 600 including abnormal noise.

FIG. 6 illustrates an example in which the vocoder 430 generated the speech 600 from a spectrogram generated based on utterer information and text.

Referring to FIG. 6, the speech 600 generated by the vocoder 430 includes abnormal noise at a specific point. A sample value 610 generating the abnormal noise may have a very large difference value from at least one of consecutive sample values 620 and 630. For example, for most sample values, a difference value between consecutive sample values is 0.2 or lower, but a difference value between the sample value 610 generating the abnormal noise and the consecutive sample value 620 is over 0.6.

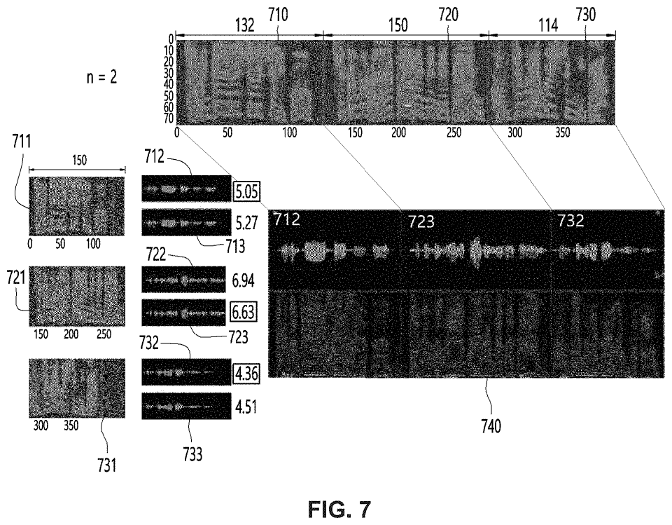

FIG. 7 is a diagram showing an embodiment of generating a final speech 740 through scoring.

Hereinafter, an example of the synthesizer 220, 300, or 420 and the speech postprocessor 440 operating to generate the final speech 740 that does not include abnormal noise will be described in detail.

It is described below that the speech postprocessor 440 calculates a score of each of a plurality of sub-speeches and selects one of the plurality of sub-speeches, but a module that calculates a score or selects a sub-speech may not be the speech postprocessor 440. For example, scores of sub-speeches may be calculated and a sub-speech may be selected by a separate module included in the speech synthesis system 100, 200, or 400 or another module isolated from the speech synthesis system 100, 200, or 400.

Also, hereinafter, a spectrogram and a mel-spectrogram may be interchangeably used. In other words, even if a spectrogram is described, the spectrogram may be replaced by a mel-spectrogram. Also, even if a mel-spectrogram is described, the mel-spectrogram may be replaced by a spectrogram.

Referring to FIG. 7, the vocoder 430 may receive, as an input from the synthesizer 420, a spectrogram and generate a plurality of sub-speeches. FIG. 7 illustrates an embodiment of generating two sub-speeches, but the disclosure is not limited thereto.

For example, as described above, the vocoder 430 determines sample values of a speech based on a probability distribution generated from logits, and thus may generate a plurality of sub-speeches from one spectrogram. In other words, a plurality of different sub-speeches may be generated from one spectrogram, based on a probability distribution.

A sub-speech may denote a speech subsidiarily generated during a process of generating a high-quality speech. For example, the speech postprocessor 440 may receive sub-speeches as inputs and output a speech that does not include abnormal noise, by using the sub-speeches.

According to an embodiment, the vocoder 430 may receive n as an input from the synthesizer 420. n is a random natural number corresponding to the number of output speeches. In the descriptions below, the plurality of sub-speeches are generated by the vocoder 430, and thus n may include a natural number equal to or greater than 2.

For example, n may be received from an external device through a communication unit included in the speech synthesis system 400. Alternatively, n may be input from a user through a user interface of the speech synthesis system 400 or selected from among natural numbers pre-stored in a database of the speech synthesis system 400, but is not limited thereto.

Referring to FIG. 7 ( [symbol] ), the vocoder 430 may generate a plurality of sub-speeches 712, 713, 722, 723, 732, and 733 ( [symbol] ) from spectrograms 711, 721, and 731 ( [symbol] ) and the speech postprocessor 440 may generate the final speech 740 based on scores of the plurality of sub-speeches 712, 713, 722, 723, 732, and 733.

The vocoder 430 may receive an input of setting n and receive, from the synthesizer 420, an input of a spectrogram, thereby generating n sub-speeches.

For example, the vocoder 430 may receive an input of setting n as 2 and receive the spectrogram 711 from the synthesizer 420, thereby generating the two sub-speeches 712 and 713. Similarly, the vocoder 430 may receive an input of setting n as 2 and receive the spectrogram 721 or 731 from the synthesizer 420, thereby generating the two sub-speeches 722 and 723 or 732 and 733.

The speech postprocessor 440 may select one of a plurality of sub-speeches generated by the vocoder 430. For example, the speech postprocessor 440 may calculate scores respectively corresponding to the plurality of sub-speeches generated by the vocoder 430. Also, the speech postprocessor 440 may select a sub-speech based on the scores respectively corresponding to the plurality of sub-speeches.

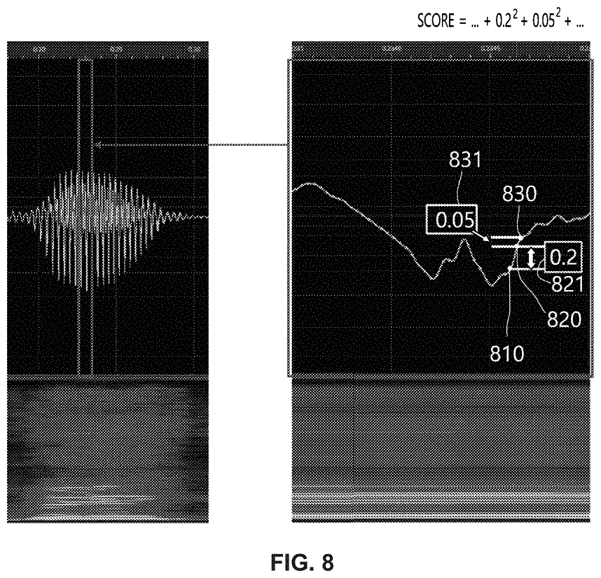

FIG. 8 is a diagram showing an example of calculating a score corresponding to a sub-speech.

Referring to FIG. 8, the speech postprocessor 440 may calculate a score corresponding to a sub-speech by using two consecutive sample values of the sub-speech. As described above, a plurality of sub-speeches are generated from one spectrogram, and thus when a difference value between s-th and (s−1)th sample values of a specific sub-speech from among the plurality of sub-speeches is greater than difference values between s-th and (s−1)th sample values of other sub-speeches by at least a certain numerical value, it is highly likely that a speech may include abnormal noise. Accordingly, the speech postprocessor 440 may calculate the score corresponding to the sub-speech to determine whether the speech includes abnormal noise.

According to an embodiment, the speech postprocessor 440 may derive an s-th score 821 based on an s-th sample value 820 and an (s−1)th sample value 810 of a sub-speech. Similarly, the speech postprocessor 440 may derive an (s+1)th score 831 based on an (s+1)th sample value 830 and the s-th sample value 820 of the sub-speech. Also, the speech postprocessor 440 may calculate a score corresponding to the sub-speech by adding the derived s-th score 821 and (s+1)th score 831. FIG. 8 illustrates an example in which the s-th score 821 is an absolute value of a difference between the s-th sample value 820 and the (s−1)th sample value 810, but the disclosure is not limited thereto.

Meanwhile, a last value of s may denote the number of samples of the sub-speech. When s is the last value, the (s+1)th sample value is not defined, and thus the (s+1)th score when the s is the last value may be defined as 0.

According to another embodiment, the s-th score 821 may be a square of the difference between the s-th sample value 820 and the (s−1)th sample value 810. A method of calculating the s-th score 821 may vary, but the s-th score 821 may be calculated to be the square of the difference between the s-th sample value 820 and the (s−1)th sample value 810, considering a calculation processing speed of the speech postprocessor 440 and comparability with an s-th score of another sub-speech.

The speech postprocessor 440 may calculate the score corresponding to the sub-speech by adding the s-th score 821 and (s+1)th score 831 calculated as such. The score described in the present embodiment may be represented as Equation 2 below.

$$score = {\sum }_{s = 1}^{l} {( {audio}_{s} - {audio}_{s - 1} )}^{2} \qquad [ Equation 2 ]$$

score denotes a score corresponding to a sub-speech, and audio denotes a sub-speech generated by a vocoder. audioₛ denotes an s-th sample value, audioₛ₋₁ denotes an (s−1)th sample value, and l denotes the number of samples of audio. Accordingly, score of Equation 2 may be a value obtained by squaring differences between two consecutive sample values throughout the sub-speech, and adding the squared differences.

Because it is determined whether each sub-speech includes abnormal noise as the speech postprocessor 440 calculates the scores respectively corresponding to the plurality of sub-speeches, the speech postprocessor 440 may select one of the plurality of sub-speeches based on the scores.

According to an embodiment, the speech postprocessor 440 may select a sub-speech of which a corresponding score is lowest from among the plurality of sub-speeches. Because it may be determined that abnormal noise is included when a difference value between the two consecutive sample values is equal to or greater than a certain numerical value, it is highly likely that a sub-speech of which a corresponding score is high includes abnormal noise. Accordingly, the speech postprocessor 440 may select the sub-speech of which the corresponding score is the lowest, so as to generate a final speech that does not include abnormal noise.

For example, referring to FIG. 7, scores corresponding to the plurality of sub-speeches 712 and 713 generated from the spectrogram 711 are 5.05 and 5.27, respectively, and thus the speech postprocessor 440 may select the sub-speech 712 of which the corresponding score is lowest from among the plurality of sub-speeches 712 and 713.

According to an embodiment, the spectrograms 711, 721, and 731 may be spectrograms 710, 720, and 730 obtained by dividing a spectrogram generated by the synthesizer 420 based on silent intervals through the synthesizer 420. Alternatively, the spectrograms 711, 721, and 731 may be obtained by postprocessing, through the synthesizer 420, the spectrograms 710, 720, and 730 divided based on the silent intervals through the synthesizer 420. For example, the postprocessing of the synthesizer 420 may be performed by calculating lengths of the spectrograms 710, 720, and 730 divided based on the silent intervals, and applying zero-padding on the spectrograms 710 and 730 having the lengths less than a reference batch length such that the calculated lengths become the same as the reference batch length.

The speech postprocessor 440 may generate a final speech by using the selected sub-speeches. The final speech may denote a corrected speech obtained as the speech postprocessor 440 corrects the speech generated by the vocoder 430.

According to an embodiment, the speech postprocessor 440 may generate the final speech 740 by determining reference intervals of the selected sub-speeches 712, 723, and 732, based on zero-padding information, and sequentially combining the reference intervals of the sub-speeches 712, 723, and 732.

According to another embodiment, the speech postprocessor 440 may generate the final speech 740 by removing residual abnormal noise from the selected sub-speeches 712, 723, and 732.

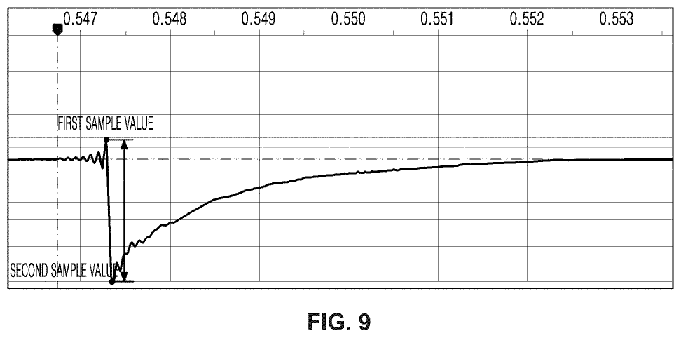

FIG. 9 is a diagram showing an embodiment of determining whether a selected sub-speech includes abnormal noise.

According to an embodiment, the speech postprocessor 440 may determine whether a difference value between consecutive first and second sample values from among sample values of the selected sub-speech is equal to or greater than a pre-set first threshold value, and when the difference value is equal to or greater than the first threshold value, determine that the sub-speech includes abnormal noise.

For example, the speech postprocessor 440 may calculate a difference value between random consecutive two sample values from among the sample values included in the sub-speech. When the difference value between the random consecutive two sample values is equal to or greater than the pre-set first threshold value, the speech postprocessor 440 may determine that the sub-speech includes abnormal noise. Alternatively, when difference values between consecutive two sample values of all sample values included in the sub-speech are less than the pre-set first threshold value, the speech postprocessor 440 may determine that the sub-speech does not include abnormal noise.

For example, the speech postprocessor 440 may set the first threshold value that is a criterion for determining whether the selected sub-speech includes abnormal noise to be 0.6, but the first threshold value is not limited thereto. Referring to FIG. 9, the difference value between the first and second sample values that are consecutive two sample values from among the sample values included in the sub-speech may be greater than 0.6, and in this case, the speech postprocessor 440 may determine that the sub-speech includes abnormal noise.

When it is determined that the selected sub-speech includes abnormal noise, the speech postprocessor 440 may correct at least one sample value from among the sample values of the selected sub-speech.

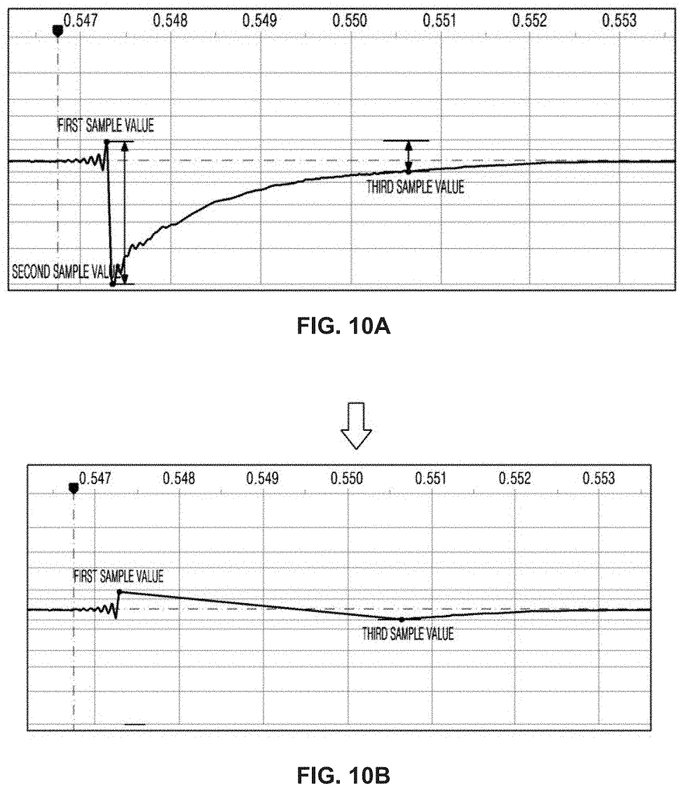

FIGS. 10A and 10B are diagrams showing an embodiment of correcting at least one sample value from among sample values of a selected sub-speech.

According to an embodiment, when a difference value between consecutive first and second sample values from among the sample values of the selected sub-speech is equal to or greater than a pre-set first threshold value, the speech postprocessor 440 may derive a third sample value corresponding to a difference value of a pre-set second threshold value with the first sample value. The speech postprocessor 440 may correct sample values located between the first sample value and the third sample value to values obtained by linearly interpolating the first and third sample values. Here, the second sample value may be included in at least one sample value located between the first sample value and the third sample value.

The speech postprocessor 440 may derive the third sample value having the difference value of the pre-set second threshold value with the first sample value from among the sample values of the selected sub-speech. Here, the pre-set second threshold value may be a value smaller than the first threshold value. For example, the speech postprocessor 440 may set the first threshold value to 0.6 and set the second threshold value to 0.05, but the first and second threshold values are not limited thereto.

Referring to FIG. 10A, the speech postprocessor 440 may derive the third sample value having the difference value of the second threshold value with the first sample value, and the second sample value may be included in the at least one sample value located between the first sample value and the third sample value.

Referring to FIG. 10B, the speech postprocessor 440 may correct the sample values located between the first sample value and the third sample value to values obtained by linearly interpolating the first sample value and the third sample value. For example, the speech postprocessor 440 may correct the sample values located between the first sample value and the third sample value to sample values derived based on a linear equation using the first sample value as a starting point and the third sample value as an ending point, but the disclosure is not limited thereto.

Finally, the speech postprocessor 440 may generate a corrected speech based on the corrected sample values. The corrected speech may correspond to a final speech obtained by removing residual abnormal noise from the selected sub-speech.

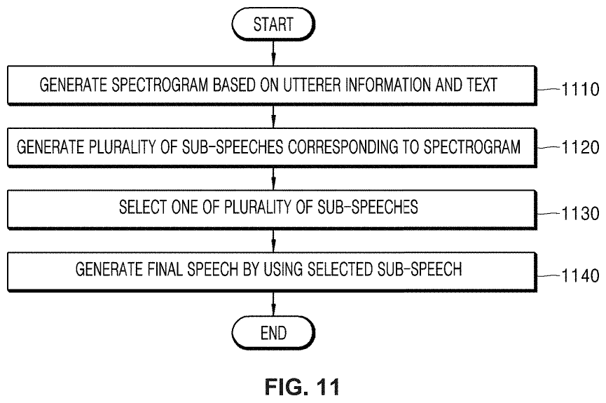

FIG. 11 is a flowchart of an embodiment of a method of synthesizing speeches by scoring the speeches.

Referring to FIG. 11, the method of synthesizing the speeches include operations that are performed in time series by the speech synthesis system 100, 200, or 400 of FIG. 1, 2, 3, or 4. Accordingly, details described above with reference to the speech synthesis system 100, 200, or 400 of FIG. 1, 2, 3, or 4 may be applied to the method of FIG. 11, even if omitted below.

In operation 1110, a speech synthesis system may generate a spectrogram based on utterer information and a text.

According to an embodiment, the speech synthesis system may receive an input of setting n corresponding to the number of a plurality of sub-speeches after generating the spectrogram, wherein n includes a natural number equal to or greater than 2, and the speech synthesis system may generate n sub-speeches.

In operation 1120, the speech synthesis system may generate a plurality of sub-speeches corresponding to the spectrogram.

In operation 1130, the speech synthesis system may select one of the plurality of sub-speeches.

According to an embodiment, the speech synthesis system may select a sub-speech based on scores respectively corresponding to the plurality of sub-speeches.

According to another embodiment, the score is calculated by deriving an s-th score based on an s-th sample value and an (s−1)th sample value of the selected sub-speech, deriving an (s+1)th score based on an (s+1)th sample value and the s-th sample value of the selected sub-speech, and adding the s-th score and the (s+1)th score, wherein s may include a natural number equal to or greater than 2.

According to another embodiment, the s-th score may be a square of a difference between the s-th sample value and the (s−1)th sample value.

According to another embodiment, a last value of s may denote the number of samples of the selected sub-speech.

According to another embodiment, the speech synthesis system may select a sub-speech of which a corresponding score is lowest from among the plurality of sub-speeches.

In operation 1140, the speech synthesis system may generate a final speech by using the selected sub-speech.

According to an embodiment, the speech synthesis system may remove residual abnormal noise from the selected sub-speech.

According to another embodiment, the speech synthesis system may determine whether a difference value between consecutive first and second sample values of the selected sub-speech is equal to or greater than a pre-set first threshold value, derive a third sample value corresponding to a difference value of a pre-set second threshold value with the first sample value, based on the difference value between the consecutive first and second sample values and the first threshold value, and correct at least one sample value from among sample values located between the first sample value and the third sample value, wherein the second sample value may be included in at least one sample value located between the first sample value and the third sample value.

When a speech synthesis system scores a speech generated by a vocoder, it may be determined whether the speech includes abnormal noise. Accordingly, the speech synthesis system may select a sub-speech that is least likely to include abnormal noise from among a plurality of sub-speeches. Also, when the selected sub-speech includes residual abnormal noise, the residual abnormal noise may be removed. Accordingly, the speech synthesis system may generate a speech having high reliability without abnormal noise.

The above description of the present specification is provided for illustration, and it will be understood by one of ordinary skill in the art that various changes in form and details may be readily made therein without departing from essential features and the scope of the disclosure as defined by the following claims. Accordingly, the embodiments described above are examples in all aspects and are not limited. For example, each component described as a single type may be implemented in a distributed manner, and similarly, components described as distributed may be implemented in a combined form.

The scope of the disclosure is defined by the appended claims rather than the detailed description, and all changes or modifications within the scope of the appended claims and their equivalents will be construed as being included in the scope of the disclosure.

What is claimed is:

1. A method, implemented by a processor, of synthesizing speeches, the method comprising:
generating a spectrogram based on utterer information and a text;
generating a plurality of sub-speeches corresponding to the spectrogram;
selecting one of the plurality of sub-speeches; and
generating a final speech by using the selected sub-speech.

2. The method of claim 1, wherein the selecting comprises selecting a sub-speech based on scores respectively corresponding to the plurality of sub-speeches.

3. The method of claim 2, wherein the scores are calculated by:
deriving an s-th score based on an s-th sample value and an (s−1)th sample value of the selected sub-speech;
deriving an (s+1)th score based on an (s+1)th sample value and the s-th sample value of the selected sub-speech; and
adding the s-th score and the (s+1)th score,
wherein s includes a natural number equal to or greater than 2.

4. The method of claim 3, wherein the s-th score is a square of a difference between the s-th sample value and the (s−1)th sample value.

5. The method of claim 3, wherein a last value of s denotes a number of samples of the selected sub-speech.

6. The method of claim 2, wherein the selecting comprises selecting a sub-speech of which a corresponding score is lowest from among the plurality of sub-speeches.

7. The method of claim 1, further comprising, after the generating of the spectrogram, receiving an input of setting n corresponding to a number of the plurality of sub-speeches,
wherein n includes a natural number equal to or greater than 2, and
wherein the generating of the plurality of sub-speeches comprises generating n sub-speeches.

8. The method of claim 1, wherein the generating of the final speech comprises removing residual abnormal noise from the selected sub-speech.

9. The method of claim 8, wherein the removing of the residual abnormal noise comprises:
determining whether a difference value between consecutive first and second sample values of the selected sub-speech is equal to or greater than a pre-set first threshold value;
deriving a third sample value corresponding to a difference value of a pre-set second threshold value from the first sample value, based on the difference value between the consecutive first and second sample values and the first threshold value; and
correcting at least one sample value from among sample values located between the first sample value and the third sample value,
wherein the second sample value is included in the at least one sample value located between the first sample value and the third sample value.

10. A non-transitory computer-readable recording medium storing instructions, when executed, configured to perform the method of claim 1.

11. A system comprising:
at least one memory storing instructions; and
at least one processor configured to execute the instructions to:
generate a spectrogram based on utterer information and a text;
generate a plurality of sub-speeches corresponding to the spectrogram;
select one of the plurality of sub-speeches; and
generate a final speech by using the selected sub-speech.

12. The system of claim 11, wherein the at least one processor is configured to select the one of the plurality of sub-speeches by selecting a sub-speech based on scores respectively corresponding to the plurality of sub-speeches.

13. The system of claim 12, wherein the at least one processor is configured to calculate the scores by:
deriving an s-th score based on an s-th sample value and an (s−1)th sample value of the selected sub-speech;
deriving an (s+1)th score based on an (s+1)th sample value and the s-th sample value of the selected sub-speech; and
adding the s-th score and the (s+1)th score,
wherein s includes a natural number equal to or greater than 2.

14. The system of claim 13, wherein the s-th score is a square of a difference between the s-th sample value and the (s−1)th sample value.

15. The system of claim 13, wherein a last value of s denotes a number of samples of the selected sub-speech.

16. The system of claim 12, wherein the at least one processor is configured to select the one of the plurality of sub-speeches by selecting a sub-speech of which a corresponding score is lowest from among the plurality of sub-speeches.

17. The system of claim 11, wherein the at least one processor is further configured to, after the spectrogram is generated, receive an input of setting n corresponding to a number of the plurality of sub-speeches,
wherein n includes a natural number equal to or greater than 2, and
wherein the plurality of sub-speeches are generated by generating n sub-speeches.

18. The system of claim 11, wherein the at least one processor is configured to generate the final speech by removing residual abnormal noise from the selected sub-speech.

19. The system of claim 18, wherein the at least one processor is configured to remove the residual abnormal noise by:
determining whether a difference value between consecutive first and second sample values of the selected sub-speech is equal to or greater than a pre-set first threshold value;
deriving a third sample value corresponding to a difference value of a pre-set second threshold value from the first sample value, based on the difference value between the consecutive first and second sample values and the first threshold value; and
correcting at least one sample value from among sample values located between the first sample value and the third sample value,
wherein the second sample value is included in the at least one sample value located between the first sample value and the third sample value.
